(19) United States
(12) Patent Application Publication
(10) Pub. No.: US 2025/0252509 A1
(43) Pub. Date: Aug. 7, 2025

(54) METHOD FOR OPTIMIZING RESOURCE USAGE FOR OIL RESERVOIR DEVELOPMENT

(71) Applicant: Abu Dhabi National Oil Company, Abu Dhabi (AE)

(72) Inventors: Sofiane TAHIR, Abu Dhabi (AE); Arwa Abdulmunim AL KINDI, Abu Dhabi (AE)

(73) Assignee: Abu Dhabi National Oil Company, Abu Dhabi (AE)

(21) Appl. No.: 18/855,795

(22) PCT Filed: Apr. 19, 2022
(86) PCT No.: PCT/IB2022/053640

§ 371 Date: Oct. 10, 2024

(51) Int. Cl. G06Q 50/02; E21B 49/08; G06Q 10/0631

(52) U.S. Cl. CPC G06Q 50/02; E21B 49/08; G06Q 10/06315

(57) ABSTRACT

The present invention relates to a computer-implemented method for optimizing resource usage for developing an oil reservoir, the method comprising receiving, for each oil reservoir of a plurality of oil reservoirs, one or more input parameters, wherein each of the one or more input parameters indicates a physical property of the corresponding oil reservoir. The method further comprises generating, for each oil reservoir of the plurality of oil reservoirs, a reservoir profile based on the corresponding one or more input parameters, wherein the reservoir profile comprises at least one probabilistic profile. In addition, the method comprises ranking the plurality of oil reservoirs based on the generated reservoir profile according to a ranking scheme, the ranking scheme comprising one or more ranking parameters and generating, for each oil reservoir of the plurality of oil reservoirs, a probability distribution of an amount of existing oil reserves of the oil reservoir for evaluating the correctness of the ranking.

### FIELD OF THE INVENTION

The present disclosure relates to a computer-implemented method, a data processing device as well as a computer program for optimizing resource usage for developing an oil reservoir.

### BACKGROUND OF THE INVENTION

In general, developing an oil reservoir is a complex process which includes the placement and installation of oil conveying systems, including devices like drilling rigs, wells, pipe systems, pipelines, tanks, control units etc. Proper functioning of all devices of an oil conveying system is mandatory. Otherwise, in the event of a malfunction, damage on the devices of the oil conveying system itself, on the environment and/or on the personnel operating the devices of the oil conveying system may be caused. Besides common abrasion of the devices caused by operation, the probability of the occurrence of a malfunction may significantly increase when the devices of an oil conveying system are oftentimes assembled and disassembled. If large oil reservoirs, including a large amount of recoverable oil, are developed, normally, assembly and disassembly of the devices required for developing the oil reservoir have to be conducted rarely. Typically, the devices of an oil conveying systems are set up and assembled once at the beginning of the development of an oil reservoir and are disassembled once when the development ends, e.g., when the oil reservoir has run out of recoverable oil. Hence, the devices of an oil conveying systems for developing an oil reservoir commonly have to be set up/assembled and dismantled/disassembled only once.

Nowadays, many so-called marginal oil reservoirs are developed. A marginal oil reservoir is a reservoir that includes an unknown or at least difficult to predict amount of recoverable oil. In most cases, it can only be determined with certainty that an oil reservoir has a sufficiently large amount of recoverable oil after it has been fully developed, i.e., only after a complete oil conveying system with all devices, like drilling rigs, wells etc., has been installed and assembled. If it turns out that the marginal oil reservoir does not provide a sufficient amount of recoverable oil, then the assembled oil conveying system including all its devices has to be disassembled/dismantled only a short period of time after it has been installed and assembled such that the oil conveying system and its devices could be transported to another oil reservoir where they may be reused for developing.

However, frequent assembly, disassembly and transportation of devices of an oil conveying system is stressful on the devices of an oil conveying system. For example, frequent loosening and tightening of bolted connections causes above-average abrasion. In addition, seals of pipelines can become brittle, which significantly increases the risk of leakage. Furthermore, load-bearing and supporting capacity of support elements can deteriorate due to frequent assembly and disassembly, which can lead to instability of the entire oil conveying system. Frequent assembly and disassembly for the purpose of moving the oil conveying system to a new oil reservoir may also increase the risk of transport damage. The frequent assembly and disassembly may also increase the risk that parts of the oil conveying system are incorrectly assembled or disassembled due to human error. Moreover, specific parts of an oil conveying system cannot be reused after having been installed. For example, pipes set up for transport of the recovered oil are typically welded together and are therefore unusable for further oil reservoir development projects. Hence, when it turns out that a marginal oil reservoir provides an insufficient amount of recoverable oil, many devices, parts and components of the corresponding oil conveying system have to replaced or at least repaired to ensure a secure operation if used to develop another marginal oil reservoir, which leads to a waste of resources in terms of materials and tools required for repairing, maintaining and/or replacing devices of the oil conveying system.

Furthermore, if a marginal oil field is developed, a large amount of energy is used, e.g., for setting up the oil conveying system and/or for the drilling processes. However, if it turns out that the marginal oil reservoir does not provide sufficient recoverable oil, then the used energy is wasted since the complete oil conveying system has to be transported to a new oil reservoir and the energy-intensive drilling processes have to be conducted again. This specifically leads to increased abrasion of the drilling equipment, as it now has to be used for an additional drilling operation in an unplanned manner. Therefore, in such cases, drill heads, for example, have to be replaced earlier or need to undergo resource-intensive maintenance, which in turn leads to inefficient use of resources in marginal oil reservoir development.

To avoid undesired abrasion of drilling equipment and to ensure a secure operation of oil conveying systems, sometimes referred to as plants or oil conveying plants, it is desirable to avoid setting up oil conveying systems at marginal oil reservoirs with only a small amount of recoverable oil. However, to determine whether a marginal oil reservoir provides a sufficient amount of recoverable oil, petrol engineers presently mainly rely on their experience since it is not possible to determine the exact amount of recoverable oil of marginal oil reservoirs with reasonable effort or by means of reasonable measurements. Given the potential risks of developing a marginal oil reservoir, deciding about the development without a data-driven evaluation/verification and solely based on an educated guess is not sufficient since this bears the risk that above-discussed negative effects (insecure operation of oil conveying systems that have moved a lot, insecure operation due to stressed material and resource waste for exchanging, repairing devices and/or energy consumption) occur.

Against this background, an object of the present invention is to provide a method for efficient resource usage for developing an oil reservoir which reduces the risk of inefficient resource usage, for example with respect to energy consumption and material abrasion that might lead to an unsecure operation of an oil conveying system installed at the oil reservoir.

### SUMMARY OF THE INVENTION

The above-mentioned problem is at least partly solved by a computer-implemented method according to claim 1, by a computer program according to claim 27, by a non-transitory computer-readable medium according to claim 28, and by data processing devices according to claims 29 and 30.

A 1^{st} embodiment of the present invention is a computer-implemented method for optimizing resource usage for developing an oil reservoir, the method comprising: receiving, for each oil reservoir of a plurality of oil reservoirs, one or more input parameters, wherein each of the one or more input parameters indicates a physical property of the corresponding oil reservoir; generating, for each oil reservoir of the plurality of oil reservoirs, a reservoir profile based on the corresponding one or more input parameters; wherein the reservoir profile comprises at least one probabilistic profile; ranking the plurality of oil reservoirs based on the generated reservoir profile according to a ranking scheme, the ranking scheme comprising one or more ranking parameters; and generating, for each oil reservoir of the plurality of oil reservoirs, a probability distribution of an amount of existing oil reserves of the oil reservoir for evaluating the correctness of the ranking.

Providing this method may allow for efficient selection of a reservoir to be developed. The generated reservoir profile may constitute a solid basis for decision-making according to a ranking scheme prioritizing different aspects of the reservoir (e.g., drilling complexity, amount of extractable oil reserves etc.). Generating an additional probability distribution may allow for further evaluation of the ranking. Accordingly, a robust method is disclosed reducing the risk of inefficient resource usage due to selection of an improper oil reservoir that only provides an insufficient amount of recoverable oil. In other words, the present method may lead to a proper selection of a marginal oil reservoir so that resource waste, caused by unnecessary assembling and dissembling of an oil conveying system, is prevented. Furthermore, energy waste may be prevented since a proper selection of a marginal oil reservoir may reduce the number drilling processes as outlined above. Furthermore, security may be improved since the reduced number of assembling and disassembling processes reduces the likelihood of erroneous installation of oil conveying systems.

According to a 2^{nd} embodiment, the one or more input parameters comprise at least one of: one or more measurement parameters of the oil reservoir;

and/or one or more pressure-volume-temperature (PVT) parameters of the oil reservoir.

Providing the additional information on the oil reservoir allows the generation of more precise reservoir profiles and probability distributions. Accordingly, the risk of selecting an improper reservoir for developing is further decreased resulting in an overall optimization of resource usage for reservoir development.

According to a 3^{rd} embodiment, the one or more measurement parameters include at least one of: a solution gas-oil ratio (GOR); an oil gravity; a gas gravity; a water salinity; a mole percent of hydrogen sulfide (H₂S); a mole percent of carbon dioxide (CO₂); and/or a mole percent of nitrogen (N₂).

According to a 4^{th} embodiment, the one or more PVT parameters include at least one of: a temperature inside the oil reservoir; a bubble point pressure; a pressure inside the oil reservoir; a GOR; an oil formulation volume factor (FVF); and/or a gas FVF.

Further specifying the measurement parameters and/or the PVT parameters allows for even more precise generation of reservoir profiles and probability distribution. Accordingly, the risk of selecting an improper reservoir for developing is further decreased. The overall resource usage for reservoir development is thus improved.

According to a 5^{th} embodiment, wherein a probabilistic profile includes: a stock tank oil initially in place (STOIIP) estimation of the amount of existing oil reserves in the oil reservoir; and a confidence level for the STOIIP estimation. A STOIIP may also be referred to as OIIP or OIP.

Associating the STOIIP estimation of the existing oil reserves in the oil reservoir with a confidence level of the estimation allows for better interpretability of the estimation. Accordingly, the ranking of reservoirs is improved as well as the evaluation as the profiles now also cover uncertainty factors of the estimations. Should an estimated amount of reserves of the reservoir with a very high confidence interval already allow for efficient resource usage, this reservoir can be developed with minimal risk of resource wastage.

According to a 6^{th} embodiment, wherein the confidence level comprises: a P10-confidence level of a STOIIP estimation of the amount of existing oil reserves of the oil reservoir; a P50 confidence level of the STOIIP estimation of the amount of existing oil reserves of the oil reservoir; and/or a P90 confidence level of the STOIIP estimation of the amount of existing oil reserves of the oil reservoir.

Providing the opportunity to define confidence levels for the estimations allows for a flexible and customizable granularity of estimations. This allows for an optimized risk evaluation and thus results in a higher chance of selecting an optimal reservoir for development.

According to a 7^{th} embodiment, generating the reservoir profile is based on a material balance method.

Generating the reservoir profile using a material balance method increases the precision of profile generation. This method is able to process the given input parameters describing physical properties of the reservoir in order to derive precise characteristics of the reservoir (e.g., the reservoir profile). Using these precise reservoir profiles decreases the risk of selecting improper reservoirs for development and instead selecting the optimal one allowing for efficient resource usage.

According to an 8^{th} embodiment, each reservoir profile further includes a reservoir specification, wherein the reservoir specification includes at least one of: a reservoir type; reserves in place, a ratio between the amount of existing oil reserves in the oil reservoir of the STOIIP estimation with the lowest confidence level and the amount of existing oil reserves in the oil reservoir of the STOIIP estimation with the highest confidence level; a scope of recovery; an area of the oil reservoir; a STOIIP density being the ratio between the amount of existing oil reserves of the oil reservoir of the STOIIP estimation and the area of the oil reservoir; a H₂S concentration; and/or an expected recovery.

Specifying the reservoir profile by one or more of the given parameters improves representability of the reservoir characteristics. The better a reservoir profile can describe the actual reservoir, the more meaningful further analysis (e.g., ranking the reservoirs based on the corresponding profiles) can be. This results in an overall increase of resource usage in reservoir development.

According to a 9^{th} embodiment, each reservoir profile further includes a reservoir requirement, wherein the reservoir requirement includes information about at least one of: a possibility for lumping; an average permeability; a viscosity; stimulation requirements; and/or a production opportunity per well.

Providing additional information about the requirements of the reservoir in the reservoir profile allows for better assessments of the reservoir and thus in an overall increase of resource usage. If for example, advanced stimulation techniques are required to extract oil from one reservoir, the complexity of the necessary infrastructure to extract the oil increases. Incorporating such information in the decision-making process allows to decrease the risk of inefficient resource usage as these additional efforts are already considered in the process.

According to a 10^{th} embodiment, the ranking scheme is selectable from a plurality of ranking schemes, the plurality of ranking schemes include: an oil production effort scheme; a net present value (NPV) scheme; and/or an accelerated reserves scheme.

A selectable/customizable ranking scheme allows for better evaluation of the reservoirs for given criteria. For example, depending on the available resources for oil extraction (e.g., availability of specific stimulation requirements or certain hardware like drilling heads etc.) one can rank the reservoirs based on the production effort. If development of complex reservoirs is currently not possible to due unavailability of a necessary drilling head, the reservoirs can be ranked according to the oil production effort scheme. One can then choose the oil reservoir with the lowest production effort according to its characteristics described by its reservoir profile. Accordingly, one can avoid the situation in which during reservoir development it is recognized that the development cannot be continued due to lack of essential hardware, devices and/or tools. This would result in a highly inefficient resource usage, which may be avoided by using the present invention.

According to an 11^{th} embodiment, each ranking parameter of the one or more ranking parameters of the ranking scheme of the plurality of ranking schemes has an adjustable weight assigned.

Selecting a ranking scheme adjusts the weight associated to the corresponding ranking parameter. Accordingly, a precise and flexible ranking mechanism is provided allowing for improved ranking of the reservoirs. This allows the selection of the optimal reservoir for development under given circumstances. This way, the resources for developing the reservoir can be used efficiently.

According to a 12^{th} embodiment, the one or more ranking parameters include at least one of: an amount of expected reserves of the oil reservoir; an uncertainty density of the oil reservoir; a STOIIP density of the oil reservoir; a surface complexity of the oil reservoir; a drilling complexity of the oil reservoir; a H₂S content of the oil reservoir; a maturity of the oil reservoir; a data availability of the oil reservoir; and/or an economics rating of the oil reservoir.

According to a 13^{th} embodiment, the economics rating is based on at least one of a NPV of the oil of the reservoir and/or a unit technical cost of the oil reservoir.

Considering the one or more ranking parameters enables the reservoirs to be ranked more precisely. Thus, a reservoir allowing with reasonable resource usage can be identified.

According to a 14^{th} embodiment, the data availability of the oil reservoir indicates a ratio of acquired data per square kilometer and is based on at least one of: one or more penetrated well logs; one or more penetrated well tests; a number of dedicated well; a number of dedicated appraisals; and/or the area of the oil reservoir.

The data availability represents a factor rating the meaningfulness of a reservoir. If a reservoir is associated with a high data availability, the corresponding reservoir profile is more likely to be meaningful. However, if a reservoir is associated with a low data availability, the reservoir profile is more likely to not describe the real characteristics of the reservoir. Accordingly, reservoirs with high data availability will be preferred by corresponding ranking schemes as a high level of uncertainty involves the risk of inefficient resource usage.

According to 15^{th} embodiment, the surface complexity of the oil reservoir based on at least one of: a facility requirement; a fluid compatibility; a well reception; a tie-in requirement; and/or health safety environment (HSE) considerations.

The surface complexity of a reservoir describes the amount of resources and efforts to be taken to develop the reservoir. A reservoir beneath a highly rugged surface may have a high surface complexity. Construction of a production infrastructure on such a surface may be complex considering the high safety requirements (e.g., HSE considerations) which plants have to meet. Considering this factor improves the precision of the reservoir ranking and thus improves resource usage efficiency.

According to a 16^{th} embodiment, the drilling complexity is based on at least one of: a subsurface congestion; an identified complication for drilling; a tight formation in the oil reservoir; and/or a necessity of an advanced simulation technique.

The drilling complexity is another factor describing the amount of resources and effort to be taken to develop the reservoir. A reservoir encapsulated by solid rock may require the usage of a special drilling head for solid rocks due to a high drilling complexity. By contrast, a reservoir associated with a low drilling complexity may be developable using a common drilling head. However, if information about the complexity is not available/incorporated in the development decision and one mistakenly uses a common drilling head on solid rock formations, this can cause severe damage on the drilling head. Accordingly, considering this factor in the ranking allows for optimized resource usage.

According to a 17^{th} embodiment, a value of a ranking parameter of the one or more ranking parameters is determined based at least on the one or more input parameters; and/or on the reservoir profile.

Determining the value of the one or more ranking parameters individually for each reservoir increases the precision of the ranking and thus efficiency of the resource usage.

According to an 18^{th} embodiment, generating the probability distribution of the amount of oil reserves of the oil reservoir comprises: determining a simulation configuration; and generating, using a Monte Carlo Simulation, based on the simulation configuration, the probability distribution of a STOIIP estimation of the amount of oil reserves of the oil reservoir.

Generating the probability distribution using a Monte Carlo Simulation based on a given simulation configuration results in a STOIIP estimation of the amount of oil reserves independent from the reservoir profile. Accordingly, an additional step of evaluating the correctness of the ranking is provided. This increases the overall precision of the method in terms of identifying a suitable reservoir for developing under improved resource usage.

According to a 19^{th} embodiment, determining the simulation configuration comprises: selecting a STOIIP estimation equation from one or more estimation equations; and selecting a sample distribution for at least one sensitivity of the selected estimation equation, preferably one of a uniform distribution, a triangular distribution, a normal distribution or a lognormal distribution.

Selecting an estimation equation and sample distribution for its corresponding sensitivities (i.e., the variables of the equation) further minimizes the risk of uncertainty of the estimation. By sampling n values for each sensitivity based on the selected sample distribution one reduces the risk of statistical outliers that would negatively affect the estimation result. The amount n of sampling iterations may be predefined or configurable. Accordingly, the overall precision of the simulation is increased, which results in the evaluation of the ranking being improved.

According to a 20^{th} embodiment, the STOIIP estimation equation comprises at least one or more of the following sensitivities: a gross rock volume (GRV) of the oil reservoir; a net to gross (NVG) of the oil reservoir; the area of the oil reservoir; a net thickness of the oil reservoir; the porosity of the oil reservoir; a water saturation of the oil reservoir; and/or an initial oil formulation volume factor.

Specifying the sensitivities of the estimation equation allows to cover all the necessary factors potentially affecting the simulation. Accordingly, covering these factors with corresponding sample distributions further minimizes the risk of uncertainty of the simulation.

According to a 21^{st} embodiment, a value of the one or more sensitivities is determined based at last one the one or more input parameters and/or the reservoir profile.

Determining the value of the one or more sensitivities based on the input parameter(s) and/or the reservoir profile individually, allows the samples being generated from the selected distribution on a more precise starting value (i.e., seed) which considers the given characteristics of the reservoir. Accordingly, the overall simulation result (i.e., the estimated amount of oil reserves) is improved.

According to a 22^{nd} embodiment, a first equation of the one or more estimation equations is specified as:

$$ST O IIP estimation = \frac{7758 \times GRV \times porosity \times ( 1 - water saturation )}{initial oil formation volume factor} .$$

According to a 23^{rd} embodiment, a second equation is specified as:

$$ST O IIP estimation = \frac{7758 \times area \times thickness \times porosity \times ( 1 - water saturation )}{initial oil formation volume factor} .$$

Selecting a corresponding estimation equation can be based on the sensitivities one aims to verify using the sampling. Selecting the first equation can be appropriate if the GRV is of main interest of verification. Selecting the second equation may be appropriate if the area and thickness of the reservoir is of main interest. One can also combine several estimation equations in case one aims at verifying a plurality of sensitivities.

According to a 24^{th} embodiment, evaluating the correctness of the ranking comprises verifying the correctness of the at least one probabilistic profile for each oil reservoir of the plurality of oil reservoirs.

Verifying the probabilistic profiles based on the probability distribution allows to determine whether the probabilistic profiles are reasonable. Accordingly, if a probabilistic profile of one reservoir profile appears to be unreasonable (e.g., the estimated amount of the probabilistic profile is not covered by the probability distribution) one can exclude this probabilistic profile from the ranking. Accordingly, the robustness of the ranking can be improved resulting in an overall efficiency increase of resource usage for reservoir development.

According to a 25^{th} embodiment, verifying comprises: extracting, for each probabilistic profile, a STOIIP estimation of an amount of existing oil reserves of the oil reservoir from the probability distribution with the same confidence level as the corresponding probabilistic profile; calculating a difference between the amount from the probability distribution and the amount from the probabilistic profile; and determining the correctness of the probabilistic profile if the difference is less than a predefined threshold.

Verification of a probabilistic profile can be achieved by extracting an estimation amount from the probability distribution having the same confidence level and determining the difference between both estimated amounts. If the difference is less than a predefined threshold (e.g., a predefined percentage of the estimated amount) then the probabilistic profile can be considered as being realistic. If not, the profile can be excluded from the ranking.

According to a 26^{th} embodiment, the method further comprises: selecting the oil reservoir for developing according to the ranking or the evaluated ranking.

Selecting a reservoir for development based on the ranking or based on the evaluated ranking constitutes an optional step of the disclosed method. Due to the previous method steps, a reservoir can be selected for which reasonable resource usage can be achieved.

A 27^{th} embodiment is a computer program comprising instructions, which when executed by a computer, cause the computer to perform the method of any one of the 1^{st} to 26^{th} embodiment.

A 28^{th} embodiment is a non-transitory computer readable medium storing computer-executable instructions which when executed by a computer, cause the computer to perform the method of any of the 1^{st} to 26^{th} embodiment.

A 29^{th} embodiment is a data processing device comprising means configured for performing the method of any of the 1^{st} to 26^{th} embodiment.

The means can be a common personal computer, a laptop or a known processing system comprising one or more processors and a memory.

A 30^{th} embodiment is a data processing device comprising: a memory; and one or more processors operatively coupled to the memory, the memory and the one or more processors configured to perform the method of any one of the 1^{st} to 26^{th} embodiment.

### BRIEF DESCRIPTION OF THE DRAWINGS

Various embodiments of the present invention are described in more detail in the following by reference to the accompanying figures without the present invention being limited to the embodiments of these figures.

FIG. 1 illustrates an overview of an oil field comprising a plurality of oil reservoirs according to an embodiment of the invention.

FIG. 2 illustrates a method for optimizing resource usage for developing an oil reservoir according to an embodiment of the invention.

FIGS. 3a-c illustrate a general structure of a reservoir profile according to an embodiment of the invention.

FIGS. 4a-b illustrate a probability distribution of an amount of existing oil reserves according to an embodiment of the invention.

FIG. 5 illustrates a graphical user interface (GUI) of a computer program according to an embodiment of the disclosure.

Throughout the present drawings and specification, the same reference numerals refer to the same elements. In the drawings, reference signs are illustrated exemplarily without limiting the embodiments of the drawings to merely comprising the illustrated reference signs.

### DETAILED DESCRIPTION

In the following, exemplary embodiments of the present invention are described in more detail.

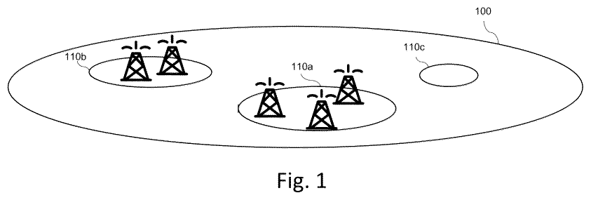

FIG. 1 depicts an overview of an exemplary oil field 100. The oil field in this example comprises three oil reservoirs 110a, 110b and 110c. Each of these oil reservoirs 110a-110c may include a certain amount of oil reserves. For example, oil reservoir 110a may include a large amount of oil reserves making the installation of three oil wells reasonable. Oil reservoir 110b may contain a smaller amount of oil reserves which makes installation of more than two oil wells unreasonable. Oil reservoir 110c may not been developed yet. Determining whether the oil reservoir 110c can efficiently developed in terms of resource usage can be achieved by applying the method underlying the present disclosure.

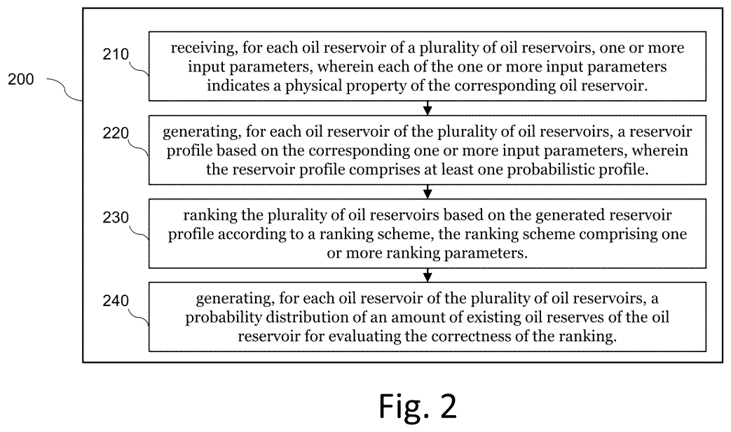

FIG. 2 depicts a flow diagram of a method 200 for optimizing resource for developing an oil reservoir 110a-110c according to an embodiment of the invention.

In step 210 of the method 200, one or more input parameters are received for each oil reservoir 110a-110c of the plurality of oil reservoirs 110a-110c, wherein each of the one or more input parameters indicates a physical property of the corresponding oil reservoir. The one or more input parameters may comprise at least one of (one or more) measurement parameters of the oil reservoir 110a-110c and/or PVT parameters (one or more). Table 1 provides an overview of possible measurement and PVT parameters of the oil reservoir 110a-110c. It is to be understood that these are only exemplary parameters.

TABLE 1

| Measurement parameters | PVT parameters |
|---|---|
| Solution gas oil ratio | Temperature inside the reservoir |
| Oil gravity | Bubble point pressure |
| Gas gravity | Pressure inside the reservoir |
| Water salinity | Gas oil ratio |
| More perfect of hydrogen sulfide | Oil formulation volume factor |
| Mole percent of carbon dioxide | gas formulation volume factors |
| Mole perfect of nitrogen | |

In step 220, a reservoir profile 300 for each oil reservoir 110a-110c of the plurality of oil reservoirs 110a-110c is generated based on the corresponding one or more input parameters, wherein the reservoir profile 300 comprises at least one probabilistic profile 340. The probabilistic profile 340 may include a STOIIP estimation of the amount 342 of existing oil reserves in the oil reservoir 110a-110c and a confidence level for the STOIIP estimation 342. These confidence levels 342 may comprise a P10 confidence level, a P50 confidence level and/or a P90 confidence level. Accordingly, in this example, three probabilistic profiles 340 may be generated wherein the first probabilistic profile 340 includes a first STOIIP estimation of the amount of oil reserves in the oil reservoir 110a-110c and a first confidence level 342, namely the P10 (i.e., 10% probability) confidence level of the corresponding STOIIP estimation. A confidence level, in this case P10, represents the likelihood that the corresponding estimated amount of oil can actually be obtained from the corresponding oil reservoir 110a-110c. In the P10 case, the estimated amount of oil can be obtained in 10% of the cases. A P50 (also referred to as a Pmean) confidence level represents a value which can be obtained in 50% of the cases and a P90 represents a value which can be obtained in 90% of the cases.

The reservoir profile 300 may be generated using material balance methods. A corresponding material balance method may for example be the material balance method as provided by the Mbal PETEX Software. Each reservoir profile 300 may include a reservoir specification 360 including at least one of a reservoir type 362 (e.g., sour or non-sour), reserves in place 364, an area 370 of the oil reservoir 110a-110c (e.g., measured in km²), a ratio 366 between the amount of existing oil reserves in the oil reservoir 110a-110c of the STOIIP estimation with the lowest confidence (e.g., P10) level 342 and the amount of existing oil reserves in the oil reservoir 110a-110c of the STOIIP estimation with the highest confidence level (e.g., P90) 342, a STOIIP density 372 being the ratio between the amount of existing oil reserves of the oil reservoir 110a-110c of the STOIIP estimation and the area 370 of the oil reservoir 110a-110c, a hydrogen sulfide concentration 374 and/or an expected recovery 376. The reservoir profile 300 may further include a reservoir requirement 380 including information about at least one of a possibility for lumping 382 (e.g., yes/no, or a probability that it is possible or not possible), a production opportunity per well 390 (i.e., how much oil can be extracted per well from the oil reservoir 110a-110c), a viscosity 386 (e.g., viscosity of the oil of the oil reservoir 110a-110c), a stimulation requirement 388 (e.g., acid fracturing, hydro fracturing etc.) for extracting the oil from the oil reservoir 110a-110c and/or an average permeability 384. Each reservoir profile 300 may further include an asset selection 320 comprising information for identifying the corresponding oil reservoir 110a-110c (e.g., operating company (OpCo) 322, asset 324, field name 326 of the oil field 100, reservoir name 328 of the oil reservoir 110a-11c and/or a unique identifier 330 of the oil reservoir 110a-110c which may be generated by concatenating the field name 326 and the reservoir name 328).

In step 230, the plurality of oil reservoirs 110a-11c is ranked based on the generated reservoir profile 300 according to a ranking scheme, the ranking scheme comprising one or more ranking parameters. The ranking scheme may be selectable from a plurality of ranking schemes. The plurality of ranking schemes may include an oil production effort scheme, a net present value (NPV) scheme and/or an accelerated reserves scheme. When choosing the oil production effort scheme the plurality of oil reservoirs 110a-110c are ranked according to their estimated effort for extracting oil. If for example oil can be extracted more easily from oil reservoir 110a than from oil reservoir 110b and that oil from oil reservoir 110b can be extracted more easily than from oil reservoir 110c, oil reservoir 110a would be ranked first, oil reservoir 110b second and oil reservoir 110c third. When choosing the NPV scheme, oil reservoirs 110a-110c are ranked according to the expected net revenue from the estimated amount of extractable oil of the oil reservoir 110a-110c-. When choosing the accelerated reserves scheme, the oil reservoirs 110a-110c are ranked according to the possibility for and/or amount of accelerated reserves of the oil reservoir 110a-110c. Additional schemes may be customizable and may be added into the plurality of ranking schemes before executing the method or during execution of the method.

The one or more ranking parameters may include at least one of an amount of expected reserves of the oil reservoir 110a-110c, an uncertainty density of the oil reservoir 110a-110c, a STOIIP density of the oil reservoir 110a-110c, a surface complexity of the oil reservoir 110a-110c, a drilling complexity of the oil reservoir 110a-110c, a H₂S content of the oil reservoir 110a-110c, a maturity of the oil reservoir 110a-110c, a data availability of the oil reservoir 110a-110c and/or an economics rating of the oil reservoir 110a-110c. The economics rating may be based on at least one of a NPV of the oil reservoir 110a-110c and/or a unit technical cost of the oil reservoir 110a-110c. The data availability may indicate a ratio of acquired data per square kilometer and is based on at least one or more penetrated well logs, one or more penetrated well tests, a number of dedicates wells, a number of dedicated appraisals and/or the are of the oil reservoir 110a-110c. The data availability may be calculated using the following equation:

$$\frac{\begin{matrix}( Penetrated Well Log ( s ) \times \text{} 0.2 ) + \\ ( Penetrated Well Test ( s ) \times 0.3 + ( Dedicated Appraisal ( s ) \times 0.5 )\end{matrix}}{Area ( {km}^{2} )}$$

The surface complexity of the oil reservoir 110a-110c may be based on at least one of a facility requirement (e.g., wells, pipes, tanks, injection facilities and controlling units), a fluid compatibility, a well reception, a tie-in requirement and/or health safety environment (HSE) considerations. One or more of these factors may be combined to generate an overall surface complexity rating. The surface complexity rating may be a rating between 1 (complex surface) to 5 (low complexity). The drilling complexity may be based on at least one of a subsurface congestion, an identified complication for drilling, a tight formation in the oil reservoir 110a-110c and/or a necessity of an advanced stimulation technique. One or more of these factors may be combined to generate an overall drilling complexity rating. The drilling complexity rating may be a rating between 1 (high complexity) to 5 (low complexity). Determining a value of one of these ranking parameters may be based on the one or more input parameters, the reservoir profile 300 and/or additional input.

In step 240, a probability distribution 400a-400b of an amount of existing oil reserves of the oil reservoir 110a-110c is generated for each oil reservoir 110a-110c of the plurality of oil reservoirs 110a-110c for evaluating the correctness of the ranking. Generating the probability distribution 400a-400b of the amount of oil reserves of the oil reservoir 110a-110c may comprise determining a simulation configuration and generating, using a Monte Carlo Simulation, based on the simulation configuration, the probability distribution 400a-400b of a STOIIP estimation of the amount of oil reserves of the oil reservoir 110a-110c. Determining the simulation configuration may comprise selecting a STOIIP estimation equation from one or more estimation equations and selecting a sample distribution (e.g., uniform, triangular, normal, lognormal distribution or any other distribution) for at least one sensitivity of the selected estimation equation.

The STOIIP estimation equation may comprise at least one or more of a gross rock volume of the oil reservoir 110a-110c, a net to gross of the oil reservoir 110a-110c, the area of the oil reservoir 110a-110c, a (net) thickness of the oil reservoir 110a-110c, the porosity of the oil reservoir 110a-110c, a water saturation of the oil reservoir 110a-110c and/or an initial oil formation volume factor. A value of the one or more sensitivities may be based at least one the one or more input parameters and/or the reservoir profile 300. For example, the value of the area of the reservoir may be 10 km² according to the reservoir profile 300 110a-110c. However, this value may be incorrect for example due to inaccuracies in measurement or other errors affecting the result. In order to generate a statistically balanced value of the reservoir area, one may generate for example 1000 sampling values using the selected sampling distribution. The value according to the profile reservoir, in this example the 10 km², may be taken as a seed for sampling. These 1000 sampling values may then be used to generate 1000 STOIIP estimations resulting in the generation of a probability distribution 400a-400b of a STOIIP estimation. This way, the risk of an incorrect or outlier value can be avoided. This risk can further be reduced by performing this step for more than one of the sensitivities of the estimation equation. A first estimation equation may be specified as

$$ST O IIP estimation = \frac{7758 \times GRV \times porosity \times ( 1 - water saturation )}{initial oil formation volume factor} \qquad Equation I$$

A second estimation equation may be specified as

$$ST O IIP estimation = \frac{7758 \times area \times thickness \times porosity \times ( 1 - water saturation )}{initial oil formation volume factor} . \qquad Equation II$$

Accordingly, in the case of equation one, the sensitivities GRV, porosity, water saturation and initial oil formulation volume factor may be sampled according to the above-described procedure. In case of the second equation, the sensitivities area, thickness, water saturation and initial oil formation volume factor may be sampled according to the above-described procedure.

Evaluating the correctness of the ranking may comprise verifying the correctness of the at least one probabilistic profile 340 for each oil reservoir 110a-110c. Verifying may comprise extracting for each probabilistic profile 340 a STOIIP estimation of an amount 410, 420, 430 of existing oil reserves of the oil reservoir 110a-110c from the probability distribution with the same confidence level as the corresponding probabilistic profile 340. A difference may be calculated between the amount 410, 420, 430 from the probability distribution 400a-400b and the amount from the probabilistic profile 340. The correctness of the probabilistic profile 340 may be determined if the difference is less than a predefined threshold. According to that (evaluated) ranking the oil reservoir 110a-110c for developing can be selected.

It is to be noted that despite shown in a specific that this is only an exemplary sequence of the method steps. It is to be understood that the order of method steps can vary and that some of the method steps may even be executed in parallel. Furthermore, it is to be understood that the general principle underlying the method may also be suitable for optimizing resource usage for developing other types of reservoirs (e.g., gas reservoirs). Accordingly, these other types of reservoirs are also covered by the present invention.

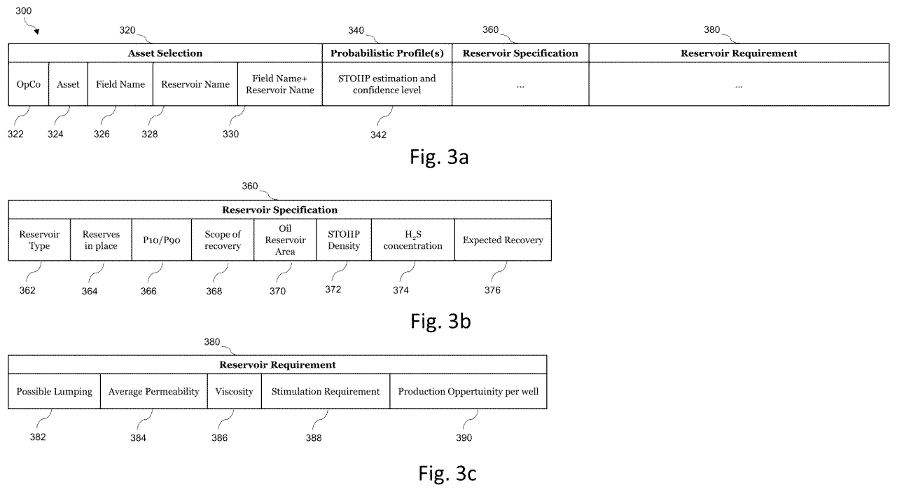

FIG. 3a-c illustrate the general structure of a reservoir profile 300 according to an embodiment of the invention. The reservoir profile 300 may be generated according to the method 200. The reservoir profile 300 as shown in FIG. 3a may consist of/include an asset selection 320, probabilistic profile(s) 340, a reservoir specification 360 and a reservoir requirement 380. The asset selection 320 may comprise information for identifying the corresponding oil reservoir 110a-110c. This information may comprise an operating company (OpCo) 322, an asset 324, a field name 326 of the oil field 100, a reservoir name 328 of the oil reservoir 110a-11c and/or a unique identifier 330 of the oil reservoir 110a-110c which may be generated by concatenating the field name 326 and the reservoir name 328. The (at least one) probabilistic profile(s) may include a STOIIP estimation of the amount of oil reserves in the oil reservoir 110a-110c and a confidence level for the (corresponding) STOIIP estimation 342.

The reservoir specification 360 as shown in FIG. 3b may include a reservoir type 362, reserves in place (e.g., this may refer to an amount of oil already extracted from the oil reservoir 110a-110c), a ratio 366 between the amount of existing oil reserves in the oil reservoir 110a-110c of the STOIIP estimation with the lowest confidence level 342 and the amount of reserves on the oil reservoir 110a-110c of the STOIIP estimation with the highest confidence level 342 (e.g., P10/P90), a scope of recovery 368, an area 370 of the oil reservoir 110a-110c, a STOIIP density being the ratio between the amount of existing oil reserves of the oil reservoir 110a-110c of the STOIIP estimation 342 and the area 370 of the oil reservoir 110a-110c, a a H₂S concentration 374 and/or an expected recovery 376.

The reservoir requirement 380 as shown in FIG. 3c may include a possibility for lumping 382, an average permeability 384, a viscosity 386, a stimulation requirement 388 and/or a production opportunity per well 390.

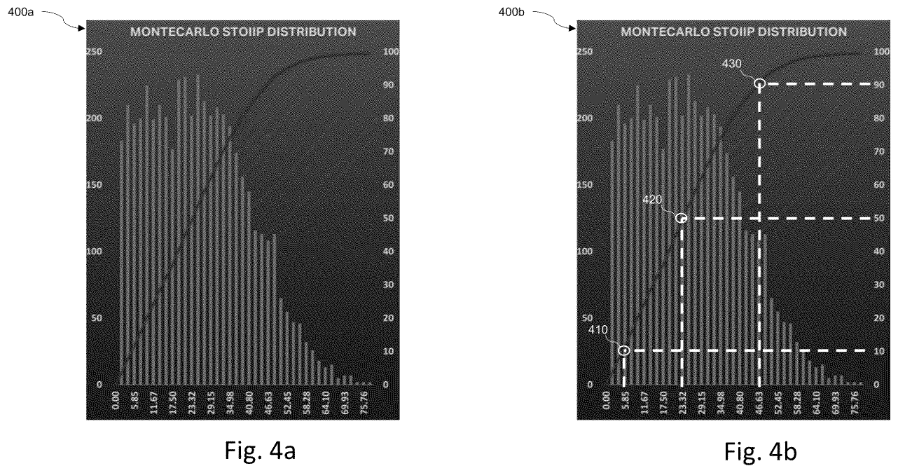

FIG. 4a-b illustrate a probability distribution 400a-b of an amount of existing oil reserves according to an embodiment of the invention. This probability distribution 400a-b may be generated in step 240 of the method 200. Accordingly, the illustrated distribution 400a-b is generated using a Monte Carlo Simulation based on a determined simulation configuration comprising a corresponding STOIIP estimation equation (e.g., equation I or II) comprising one or more sensitivities and a sample distribution. FIGS. 4a-b depict exemplary distributions 400a-b generated using around 5000 samples. Each sample represents the estimated STOIIP. At the bottom scale the range of estimated STOIIP is shown ranging from 0.00 STOIIP up to 75.76 STOIIP. The left scale depicts the amount of samples which have estimated the corresponding STOIIP amount. For example, around 210 samples of the overall 5000 samples have estimated an amount of 5.85 STOIIP. The right scale depicts the accumulated distribution. For example, 90% of the around 5000 samples have estimated a STOIIP of equal to or less than 46. 63 430. 50% of the around 5000 samples have estimated a STOIIP of equal to or less than 23.32 420. Finally, 10% of the around 5000 samples have estimated a STOIIP of equal to or less than 5.85 410.

According to method 200, such a distribution 400a-b may be used to evaluate the correctness of the ranking. This may be done by verifying the correctness of the at least one probabilistic profiles 340 of each oil reservoir 110a-110c of the plurality of oil reservoirs 110a-11c. Verifying may comprise extracting, for each probabilistic profile 340, a STOIIP estimation 410, 420, 430 of an amount of existing oil reserves of the oil reservoir 110a-110c from the probability distribution 300 with the same confidence level 342 as the corresponding probabilistic profile 340, calculating a difference between these amounts and determining the correctness of the probabilistic profile 340 if the difference is less than a predefined threshold. In the following, an example is illustrated explaining these steps of the method 200 in detail.

For instance, assuming the reservoir profile 300 contains a first probabilistic profile 340. The first probabilistic profile 340 containing an STOIIP estimation of 50 associated with a 10% confidence level 342. For instance, according to the first probabilistic profile 340, (at least) 50 STOIIP can be extracted in 10% of the cases. In order to verify this probabilistic profile 340, a STOIIP estimation 430 is extracted from the generated probability distribution 400b with the same confidence level (10%) as the probabilistic profile 340. In this example, the extracted STOIIP estimation 430 would be a STOIIP of 46.63. This is because in 90% of cases the estimated STOIIP is less than or equal to 46.64. Accordingly, in 100%-90%=10% of cases the STOIIP is more than 46.63. After the extraction, a difference is calculated between both amounts. In this example, one could calculate this difference by either diff=|50−46.63|=3.37 or diff=|46.63−50|=3.37. In order to determine the correctness of the first probabilistic profile 340 the difference is then compared to a predefined threshold. The threshold may be an absolute value (e.g., 10 STOIIP) or a relative value (e.g., 10% of the estimated amount of either the probability distribution 400a-b or the probabilistic profile 340, 342). In this example, assuming the threshold was defined to be 10% of the value of the probability distribution 400b, thus threshold=0.1×46.63=4.663. Accordingly, in this example the method 200 would determine that the first probabilistic profile 340 is correct as 3.37<4.663. From this one can follow that the rank of the corresponding oil reservoir 110a-110c is correct which minimizes the risk of inefficient resource usage when developing the oil reservoir 110a-110c.

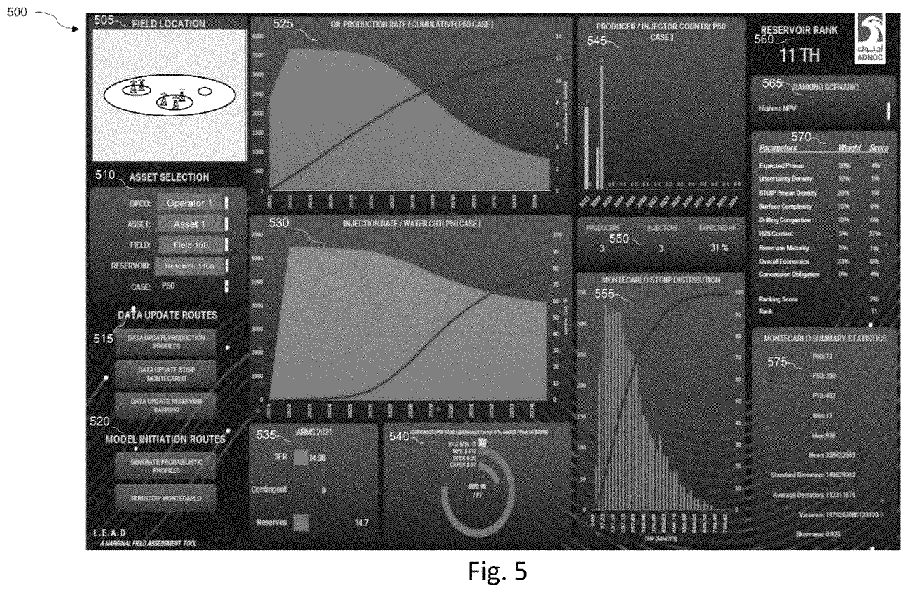

FIG. 5 illustrates a graphical user interface (GUI) 500 of a computer program according to an embodiment of the disclosure. The GUI 500 allows the user to select an oil field 100 and a corresponding oil reservoir 110a-110c of the oil field 100 via the asset selection 510 option. Furthermore, the user can get information about the location of the oil field 100 via the GUI element field location 505. Via the GUI elements data update routes 515 and model initiation routes 520 the user can cause the computer program underlying the GUI 500 to carry out a method 200 according to an embodiment of the present disclosure. The user can select via the asset selection 510 option a case (i.e., probabilistic profile 340) of the selected oil reservoir 110a-110c, for example the P50 case. According to the selected case, the GUI elements oil production rate 525, injection rate/water cuts 530, ARMS (e.g., advanced reservoir modeling & simulation) 535, economics 540, producer/injector counts 545, 550 and the corresponding probability distribution 555 with additional summary statistics 575 are updated. The user is also presented with a reservoir rank 560 resulting for example from the ranking step of method 200. The currently selected ranking scheme 565 as well as the corresponding weightage of the ranking parameters 570 (e.g., amount of expected reserves for the selected case, uncertainty density, STOIIP density of the selected case, surface complexity, drilling congestion/complexity, H₂S content, reservoir maturity, data availability and/or economics rating) are also displayed.

A user is given the option to change the ranking scheme 565 or adjust the weight(s) of one/some/all ranking parameter(s) 570 which results in re-execution of some or all of the method steps of method 200 and finally in a new rank 560 of the selected oil reservoir 110a-110. The asset selection GUI element 510 may indicate the information of the asset selection 320 (e.g., opco 322, asset 324, field name 326, reservoir name 328 and/or field name+reservoir name 330) of the generated reservoir profile 300. The selectable cases of the asset selection GUI element 510 may refer to the probabilistic profiles 340 of the generated reservoir profile 300 (i.e., if a P10, a P50 and P90 probabilistic profile was generated the user has the option to choose between these 3 cases). The oil production rate GUI element 525 may indicate the STOIIP estimation with the corresponding confidence level 342 of a probabilistic profile 340 according to the selected case. The STOIIP estimation may be indicated as a cumulative amount of oil over the years of extraction. The GUI element injection rate/Water cut 530 may indicate the corresponding amount of water injected into the oil reservoir 110a-110c necessary for extracting the oil. GUI element ARMS 535 may indicate the values of reserves in pace 364 and scope of recovery 368 of the reservoir specification 360 of the corresponding reservoir profile 300. The economics GUI element 540 may indicate values related to the economics rating ranking parameters like a net present value and/or a unit technical cost of the oil reservoir 110a-c. The producer/injector counts GUI elements 545, 550 may indicate the number of producers and injectors (e.g., 3) and the corresponding expected recovery 376 of the reservoir specification 360 of the corresponding reservoir profile 300. The summary statistics GUI element 575 may indicate values relating to the generated probability distribution 400a-b indicated by GUI element 555. The statistics may include extracted STOIIP amounts 410, 420, 430 for the confidence levels 342 of the generated probabilistic profiles 340 of the reservoir profile 300. The statistics may also include values like the standard deviation, average deviation, variance and skewness of the indicated probability distribution 400a-b.

The computer program may be executed on any suitable data processing device comprising means (e.g., a memory and one or more processors operatively coupled to the memory) being configured accordingly. The computer program may be stored as computer-executable instructions on a non-transitory computer-readable medium.

Embodiments of the present disclosure may be realized in any of various forms. For example, in some embodiments, the present invention may be realized as a computer-implemented method, a computer-readable memory medium, or a computer system.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a computing device may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. In particular, with reference to the appended claims, features from dependent claims may be combined with those of the independent claims and features from respective independent claims may be combined in any appropriate manner and not merely in the specific combinations enumerated in the appended claims.

1. A computer-implemented method for optimizing resource usage for developing an oil reservoir, the method comprising:
receiving, for each oil reservoir of a plurality of oil reservoirs, one or more input parameters, wherein each of the one or more input parameters indicates a physical property of the corresponding oil reservoir;
generating, for each oil reservoir of the plurality of oil reservoirs, a reservoir profile based on the corresponding one or more input parameters,
wherein the reservoir profile comprises at least one probabilistic profile; wherein a probabilistic profile includes:
a stock tank oil initially in place, STOIIP, estimation of the amount of existing oil reserves in the oil reservoir; and
a confidence level for the STOIIP estimation;
ranking the plurality of oil reservoirs based on the generated reservoir profile according to a ranking scheme, the ranking scheme comprising one or more ranking parameters; and
generating, for each oil reservoir of the plurality of oil reservoirs, a probability distribution of an amount of existing oil reserves of the oil reservoir for evaluating the correctness of the ranking.

2. The method of claim 1, wherein the one or more input parameters comprise at least one of:
one or more measurement parameters of the oil reservoir; and/or
one or more pressure-volume-temperature, PVT, parameters of the oil reservoir.

3. The method of claim 2, wherein the one or more measurement parameters include at least one of:
a solution gas-oil ratio, GOR;
an oil gravity;
a gas gravity;
a water salinity;
a mole percent of hydrogen sulfide, H₂S;
a mole percent of carbon dioxide, CO₂; and/or
a mole percent of nitrogen, N₂.

4. The method of claim 2, wherein the one or more PVT parameters include at least one of:
a temperature inside the oil reservoir;
a bubble point pressure;
a pressure inside the oil reservoir;
a GOR;
an oil formulation volume factor, FVF; and/or
a gas FVF.

5. The method of claim 1, wherein the confidence level comprises:
a P10 confidence level of a STOIIP estimation of the amount of existing oil reserves of the oil reservoir;
a P50 confidence level of the STOIIP estimation of the amount of existing oil reserves of the oil reservoir; and/or
a P90 confidence level of the STOIIP estimation of the amount of existing oil reserves of the oil reservoir.

6. The method of claim 1, wherein generating the reservoir profile is based on a material balance method.

7. The method of claim 1,
wherein each reservoir profile further includes a reservoir specification, wherein the reservoir specification includes at least one of:
a reservoir type;
reserves in place;
a ratio between the amount of existing oil reserves in the oil reservoir of the STOIIP estimation with the lowest confidence level and the amount of existing oil reserves in the oil reservoir of the STOIIP estimation with the highest confidence level;
a scope of recovery;
an area of the oil reservoir;
a STOIIP density being the ratio between the amount of existing oil reserves of the oil reservoir of the STOIIP estimation and the area of the oil reservoir;
a H₂S concentration; and/or
an expected recovery.

8. The method of claim 1, wherein each reservoir profile further includes a reservoir requirement, wherein the reservoir requirement includes information about at least one of:
a possibility for lumping;
an average permeability;
a viscosity;
a stimulation requirement; and/or
a production opportunity per well.

9. The method of claim 1, wherein the ranking scheme is selectable from a plurality of ranking schemes, the plurality of ranking scheme includes:
an oil production effort scheme;
a net present value, NPV, scheme; and/or
an accelerated reserves scheme.

10. The method of claim 1, wherein each ranking parameter of the one or more ranking parameters of the ranking scheme of the plurality of ranking schemes has an adjustable weight assigned.

11. The method of claim 1, wherein the one or more ranking parameters include at least one of:
an amount of expected reserves of the oil reservoir;
an uncertainty density of the oil reservoir;
a STOIIP density of the oil reservoir;
a surface complexity of the oil reservoir;
a drilling complexity of the oil reservoir;
a H₂S content of the oil reservoir;
a maturity of the oil reservoir;
a data availability of the oil reservoir; and/or
an economics rating of the oil reservoir.

12. The method of claim 11, wherein the economics rating is based on at least one of a NPV of the oil reservoir and/or a unit technical cost of the oil reservoir.

13. The method of claim 11, wherein the data availability of the oil reservoir indicates a ratio of acquired data per square kilometer and is based on at least one of:
one or more penetrated well logs;
one or more penetrated well tests;
a number of dedicated wells;
a number of dedicated appraisals; and/or
the area of the oil reservoir.

14. The method of claim 11, wherein the surface complexity of the oil reservoir is based on at least one of:
a facility requirement;
a fluid compatibility;
a well reception;
a tie-in requirement; and/or
health safety environment, HSE, considerations.

15. The method of claim 11, wherein the drilling complexity is based on at least one of:
a subsurface congestion;
an identified complication for drilling;
a tight formation in the oil reservoir; and/or
a necessity of an advanced stimulation technique.

16. The method of claim 1, wherein a value of a ranking parameter of the one or more ranking parameters is determined based at least on the one or more input parameters and/or on the reservoir profile.

17. The method of claim 1, wherein generating the probability distribution of the amount of oil reserves of the oil reservoir comprises:
determining a simulation configuration; and
generating, using a Monte Carlo Simulation, based on the simulation configuration, the probability distribution of a STOIIP estimation of the amount of oil reserves of the oil reservoir.

18. The method of claim 17, wherein determining the simulation configuration comprises:
selecting a STOIIP estimation equation from one or more estimation equations; and
selecting a sample distribution for at least one sensitivity of the selected estimation equation, preferably one of a uniform distribution, a triangular distribution, a normal distribution or a lognormal distribution.

19. The method of claim 18, wherein the STOIIP estimation equation comprises at least one or more of the following sensitivities:
a gross rock volume, GRV, of the oil reservoir;
a net-to-gross, NVG, of the oil reservoir;
the area (370) of the oil reservoir;
a net thickness of the oil reservoir;
the porosity of the oil reservoir;
a water saturation of the oil reservoir; and/or
an initial oil formation volume factor.

20-28. (canceled)

29. A data processing device comprising:
a memory; and
one or more processors operatively coupled to the memory, the memory and the one or more processors configured to perform the method of claim 1.

30. (canceled)
